(19) United States
(12) Patent Application Publication
(10) Pub. No.: US 2004/0049450 A1
(43) Pub. Date: Mar. 11, 2004

(54) Method and apparatus for coordinating real estate closing services

(76) Inventor: Sherin B. Lussler, North Providence, RI (US)

Correspondence Address: Norma E. Henderson, Hinckey, Allen & Snyder LLP, 43 North Main Street, Concord, NH, 03301-4934, US

(21) Appl. No.: 10/655,356

(22) Filed: Sep. 4, 2003

Related U.S. Application Data
(60) Provisional application No. 60/407,715, filed on Sep. 4, 2002.
(60) Provisional application No. 60/459,173, filed on Mar. 31, 2003.

(51) Int. Cl. G06F 17/60

(52) U.S. Cl. 705/38

(57) ABSTRACT

Real estate closing service providers are matched with customers according to multiple predefined criteria, allowing the customer to choose from a list of matching service providers that have been pre-approved by the lender. The method is advantageously implemented by performing many of the steps via the Internet and with the assistance of appropriate computer software, but may be implemented utilizing any other suitable means. In one embodiment, a service provider coordinator coordinates the matching of customers and service providers. Lenders provide the coordinator with lists of approved providers, service providers provide outlines of closing costs, discount incentives, and customer requirements, and customers provide closing information. The coordinator screens the requirements for each customer transaction type and matches the customer with appropriate service providers. The customer selects a service provider from the matches and informs the coordinator and/or lender of the choice. The coordinator then informs the service provider and/or the lender and coordinates the closing. Upon closing, the service provider, the lender, and/or the customer pay the coordinator a referral fee for its services. Information about the transaction, the offer, and/or the customer may be optionally stored for future use. In various alternative embodiments, a customer may initiate contact with the coordinator, a lender may act as an intermediary between a customer and the coordinator, a lender may initiate contact between a customer and the coordinator, and/or a service provider may utilize the coordinator as a source of prescreened business.

### RELATED APPLICATIONS

This application claims priority to U.S. Provisional Application Ser. No. 60/407,715, filed Sep. 4, 2002, and U.S. Provisional Application Ser. No. 60/459,173, filed Mar. 31, 2003.

### FIELD OF THE INVENTION

The invention relates to coordination of professional services and, in particular, to a method and apparatus for matching and referring real estate closing service providers and customers.

### BACKGROUND

Consumers spend hundreds, if not thousands, of dollars on settlement charges when they either purchase or refinance a home. Most often, the consumer has little to no knowledge about the necessity of each closing service or its cost, and most borrowers are not told final settlement service costs until they are actually sitting down at the closing table.

All residential real estate closings, whether purchases or refinances, require substantially the same professional services from service providers. Until now, there has been no way for a buyer or seller to search for and compare closing services from a multitude of potential service providers without physically going to or calling each service provider in order to request closing service information. This process is tedious and time consuming and is therefore rarely used. Closing service providers, such as attorneys and appraisers, are therefore most often chosen for the consumer by the lender providing the funding for the real estate transaction, with little or no input from the consumer. This method does not provide the consumer with any real opportunity to compare the price and costs of these services. Often, consumers do not even know what fees these service providers charge until the day of the real estate closing, so they therefore have little opportunity to negotiate or get discounted closing fees from service providers. Even if a prospective borrower does attempt to minimize the amount of the expected closing costs during the application process, a lender will often respond by simply raising either the borrower's loan amount or the interest rate on the loan in order to cover the cost of the settlement fees, rather than by attempting to actually lower the fees.

At present, many lending institutions and mortgage brokers choose to work with those service providers with whom they have developed business or personal relationships, rather than to seek out the lowest costs for their borrowers. Because lenders and brokers tend to consistently choose the same service providers and refer substantial amounts of closings to them, a monopolizing effect results in the industry. This tends to prevent other closing service providers from entering into the market place. Further, because the flow of business is dictated by the lender/broker, there is little incentive for service providers to offer competitive pricing or discounts. In addition, since most consumers are unaware of this arrangement, they do not even realize that lower closing costs may be available to them through a different service provider.

Real estate appraisers are also frequently chosen for the customer by the lender or broker. Often, customers are not informed of potential cost savings regarding appraisals. For instance, if a customer recently had a property appraisal done in connection with a prior refinance, the lender might only actually require that the customer get an abbreviated appraisal or a recertification of value, rather that a full appraisal. Similarly, a title company might not require a customer to pay for a full title policy if one had recently been purchased, but rather might allow the customer to pay for a re-issue of the title policy, thus saving the customer money. Because the service provider is chosen for the customer by the lender or broker, there is little incentive for either the service provider or the lender to inform the customer of these potential discounts.

Moreover, service providers are not driven to compete for customers by offering reduced fees and discounts for services. For example, attorneys can set, adjust, and manipulate the costs of a closing on the settlement statement as they see fit. Customers are often unaware of what costs they are paying for or exactly what service each cost represents. On the settlement statement, one line is typically labeled “Attorneys Fees”, with the result that consumers frequently think that the cost listed on that line represents the entire amount that they are paying for the closing legal fees. However, in many instances, the attorney also charges the customer for other services, such as document preparation, for example, so that the customer may pay upwards of $100 for a single sheet of paper. The attorney may also mark up the fees charged for services provided by others, such as title insurance, and keep the difference.

Further, many closing attorneys spend countless hours attempting to attract business from mortgage brokers and lenders. The Real Estate Settlement Procedures Act (RESPA) prohibits lenders or service providers from splitting fees or offering kickbacks for real estate settlement services. Third parties may only split fees with lenders or settlement providers if the third party “actually performs services” for the consumer and if the third party discloses the fee splitting to the consumer before the closing. Because the attorney is prohibited from fee splitting with the broker/lender, and because the attorney is prohibited from giving kickbacks to the broker/lender, time and effort must be spent trying to attract mortgage brokers and lenders in order to get the referrals needed to run a real estate closing practice. In order to accommodate brokers, attorneys often travel great distances to meet customers at their homes or elsewhere in order to perform the closing. Moreover, closings typically must be scheduled at all hours of the day and night, as well as on weekends, in order to accommodate brokers and the promises brokers make to customers regarding closings. While consumers are given the impression that these personal convenience accommodations are free of cost, in actuality the costs of the attorney's travel and time are ultimately passed onto consumers in the form of higher attorney's fees.

The United States Department of Housing and Urban Development (HUD) has, for several years, been attempting to make the real estate settlement process easier, faster, and cheaper, as well as to streamline and improve disclosures to consumers. HUD has also been trying to promote competition in the industry by removing existing legal barriers to the bundling of settlement charges. So far, HUD has not been able to enact legislation that accomplishes these goals sufficiently.

Some lenders have begun offering “fixed” settlement costs or “bundling” of settlement charges. Most of the costs that are “fixed”, however, are the broker and lender fees associated with the loan and, infrequently, the attorney fee disclosed on one line of the HUD settlement statement. The other costs associated with the closing, such as recording fees, title policy costs, and others listed above, remain flexible and may be marked up or changed, either prior to or at closing, with little or no notice to the customer. Sometimes, the lender even has the borrower escrow extra money at closing to cover the extra costs.

Frequently, the loan agreement purports that there will be no change in agreed costs from time of application until time of closing, but only so long as nothing else in the transaction changes. If interest rates, the required loan amount, or other variables change, then the so-called “fixed” cost can be increased. In actual practice, during the loan process there is almost always some change between the figures presented on the application documents and the numbers ultimately used at closing. Reasons for these changes include such things as difficulties with the borrower's credit history, prior existing loan obligations, and appraised value of the home. Such factors are difficult to foresee at the time of application, and therefore there is almost always some change in the loan package prior to closing, thus allowing the “fixed costs” to be altered in virtually every instance. Moreover, such “fixed cost” programs do not explain each service in detail or necessarily offer all available discounts to the customer and therefore do not allow customers to negotiate further discounts from service providers.

Another disadvantage of “fixed closing cost” programs is that sometimes the borrower may “shop” for a loan based solely on the amount of the “fixed closing cost”. Such borrowers often receive the good faith estimate of the entire transaction costs only after paying the lender's application fee. The borrowers often remain unaware of the interest rate and required points, as well as of other broker's fees at time of paying the application fee, and therefore are choosing a lender based solely on the “fixed closing cost” fee instead of the more important, and costly, variables of the loan, such as interest rates and points.

Other disadvantages of most current methods for coordinating real estate closing services arise from the typically “manual” nature by which such transactions are arranged and processed. As discussed above, the industry is still highly dependent on the selective actions of people, much of which are implemented through the movement of paper. Most transactions are still set up, controlled, and finalized through faxing, mailing, or even hand-carrying of paper documents between the lender, the customer, and the various closing service providers.

Computer networking has become one of the most effective ways for businesses to communicate and transact business internally, with other businesses, and with individuals. Most companies that conduct business over the Internet do so through email or via web pages. Various methods are known in the art for building computer networking systems and for presenting web pages over the Internet. For example, U.S. Pat. No. 5,701,451 to Rogers et al., discloses one mechanism by which the requests of a web browser are processed. The Rogers invention speeds up the process for receiving requests from web browser users and retrieving the required information. In the real estate field, only tentative steps have been taken toward taking advantage of this new technology. One example is described in U.S. Pat. No. 6,385,594 to Lebda et al., which discloses a process for coordinating various types of loans between lending institutions and potential borrowers via the Internet.

What has been needed, therefore, is a process that allows consumers to quickly and conveniently choose closing services from among offers made by a number of service providers. What has especially been needed is a process for closing service provider selection by the customer that is easily accessible to the customer, preferably via the customer's home computer, and that is as automated as possible.

### OBJECTS OF THE INVENTION

Accordingly, an object of the present invention is to provide a fast, convenient process that allows consumers to choose closing services from among a number of service providers. It is a particular object of the present invention to provide a customer with a closing data form in advance of the actual closing, either over the Internet or otherwise, that may then be submitted to be matched with the service criteria of a plurality of service providers in order to solicit multiple offers of services from which to select. It is a particular object of one aspect of the present invention to provide the customer with an electronic closing data form that may be submitted by the customer or lender via the Internet to be matched in an automated manner to a plurality of service providers who in turn respond to the customer or lender over the Internet with offers of services from which the customer may make a selection.

### SUMMARY

These and other objectives are met by the present invention, which is a method and apparatus for coordinating lenders, customers, and a plurality of real estate closing service providers. The invention provides a system whereby service providers are matched with customers according to multiple criteria established by the lender, the customer, and the service provider prior to the match. The customer may therefore choose a service provider from a group of matching service providers that have been pre-approved by the lender. In particular, the service provider may offer various closing cost discounts to the borrower in order to attract more business, stimulating competition amongst these providers.

The method of the present invention is most advantageously implemented by performing many of the steps via the Internet and with the assistance of appropriate computer software; however, the invention may also satisfactorily employ traditional forms of communication, such as the telephone, fax machines, paper, and any other suitable means of communication known in the art to implement the various steps of he method of the invention.

In one embodiment of the present invention, a service provider coordinator coordinates the matching of customers and service providers. The lenders provide the coordinator with lists of approved service providers, and the service providers provide the coordinator with outlines of closing costs and discount incentives, as well as any requirements as to customers that they will serve. The coordinator screens the requirements for each customer transaction type and then matches the customer with appropriate service providers that are approved by the lending institution being used by the customer. The customer selects a service provider from the matches and informs the coordinator and/or lender of the choice. The coordinator then informs the service provider and/or the lender and coordinates the closing. Upon closing, the service provider, the lender, and/or the customer pay the coordinator a referral fee for its services. In one embodiment, the customer is provided with an early disclosure form, wherein each cost that will be listed on the settlement sheet is thoroughly explained, along with detail of the actual service to be provided and the approximate time such service is anticipated to take. The customer may then make an informed decision when choosing the service provider.

In various alternative embodiments, a customer may initiate contact with the coordinator, a lender may act as an intermediary between a customer and the coordinator, a lender may initiate contact between a customer and the coordinator, and/or a service provider may utilize the coordinator as a source of prescreened business. In the lenders intermediary embodiment, the coordinator typically provides service documentation to the lender to provide to the customer. The lender then provides the customer with an explanation of each closing service that will be charged to the customer at closing, and explains the options that the customer may take advantage of in the closing process.

In a particular embodiment, the service provider coordinator requests closing data from or about the customer. When the data is received, it is optionally validated. The data is then optionally stored and/or manipulated prior to identifying at least one matching service provider. An offer is then solicited and received from at least one matching service provider or, alternatively, an offer is constructed from the matching service provider's standard terms. The customer is then notified of at least one matching service provider offer. After the customer decides which, if any, offer to accept, the customer's decision is received and an accepted service provider, if any, is notified of the referral. The service provider information and a record of the accepted offer are then provided to the customer. If desired, information about the transaction, the offer, and/or the customer may be optionally stored for future use.

In a preferred embodiment, a method and apparatus is provided for coordinating an electronic closing data form between a customer and a plurality of service providers via the Internet. The method comprises the steps of displaying a plurality of documents to an Internet user, receiving a plurality of closing data sent from the Internet user, matching an electronic closing data form to a filter comprising a plurality of service provider selection criteria, transmitting the closing data to a plurality of matched service providers, and responding to the customer via the Internet.

The present invention therefore makes the real estate closing process easier, faster, and cheaper, and streamlines and improves the disclosures made to consumers early in the closing process. This invention allows for greater scrutiny of closing costs by borrowers, and enables lenders and borrowers to participate in the fee setting process, thereby promoting competition in the field and giving greater value to the consumer. The invention also provides an incentive to lenders to utilize the method and offer the cost savings to their borrowers.

### BRIEF DESCRIPTION OF THE DRAWINGS

FIG. 1 illustrates an embodiment of the method for coordinating real estate closing services of the present invention;

FIG. 2 illustrates a preferred embodiment of the method of the present invention, wherein real estate closing services are coordinated between customers and closing service providers via the Internet;

FIG. 3 is a schematic depiction of one embodiment of a network suitable for implementing the embodiment of FIG. 2;

FIG. 4 illustrates another embodiment of the method of the present invention, wherein a lender is utilized as an intermediary between the customer and the closing service provider coordinator;

FIG. 5 illustrates another embodiment of the method of the present invention, wherein a lender employs a service provider coordinator and continues to provide services to the customer throughout the matching process; and

FIG. 6 illustrates yet another embodiment of the method of the present invention, wherein a service provider utilizes the services of a service provider coordinator in order to provide customers with offers of services.

### DETAILED DESCRIPTION

The Internet has become a cost effective medium for the transaction of business by both commercial and personal entities. To conduct business over the Internet, companies most often communicate with potential customers via web pages or e-mail. The coordination of a computer network with web pages, email, or other forms of communication therefore creates an effective means by which to inform customers about, and provide them with, settlement service costs before a real estate closing, allowing the consumer a choice of service providers and prompting competition in the settlement service industry. The method of the present invention is therefore most advantageously implemented by performing many of the steps via the Internet and with the assistance of appropriate computer software. However, while the Internet provides speed, convenience, and the benefits of e-mail communications, the invention may also be implemented utilizing traditional forms of communication, such as the telephone, fax machines, paper, and any other suitable means known in the art.

In one embodiment of the present invention, a centralized service provider coordinator coordinates the matching of customers and service providers. The coordinator is typically a separate entity from the other parties to the transaction, but may also be a department, division, or even a designated individual within another entity such as a lender or customer. The lenders provide the coordinator with lists of approved service providers, and the service providers provide the coordinator with outlines of closing costs and discount incentives, as well as any requirements as to types of customers that they will serve. The coordinator screens lenders' and brokers' requirements for each customer transaction type and then matches the customer with appropriate service providers that are approved by the lending institution being used by the customer. The customer selects a service provider from the matches and informs the coordinator and/or lender of the choice. The coordinator then informs the service provider and/or the lender and coordinates the closing. Upon closing, the service provider, the lender, and/or the customer pay the coordinator a referral fee for its services.

Initial contact with the coordinator may be directly from the customer via the Internet, by telephone, by mail, or by any other suitable means known in the art. In one embodiment of the present invention, the customer is provided with a closing data form over the Internet, by mail, or by any other suitable means known in the art. In an embodiment that employs the Internet, the coordinator submits a single customer closing data form to a plurality of suitable service providers who then make offers for services directly to the customer via the Internet or any other suitable method. In an alternate embodiment, service providers provide the coordinator with their standard costs, fees and discounts. After filtering the customer's data to match the service provider's criteria, preferably via computerized filters and databases controlled by the coordinator, the coordinator submits one or more service provider standard offers to the customer via the Internet or any other suitable method. In another alternate embodiment, lenders and brokers are networked with the coordinator in such a manner that the needed information may be gleaned directly from the customer's loan application documents, allowing offers for services to be distributed by the lender directly to the applicant.

The coordinator may also get lender and/or mortgage broker-initiated customer referrals. By referring the customer to the coordinator, the lender offers the customer the benefits and advantages of price comparison and thorough disclosure and explanation of closing costs and services. The coordinator provides service documentation to the lender to provide to the customer. The lender provides the customer with an explanation of each closing service that will be charged to the customer at closing, and explains the multitude of options that the customer may take advantage of in the closing process. For instance, the customer may be informed of several title options, such as re-issue rates on title policies, and of potential costs savings offered by title companies who issue title and also perform their own closings. The option of an abbreviated appraisal may also be offered and explained to the customer.

In one embodiment, the customer is provided with an early disclosure form, wherein each cost that will be listed on the settlement sheet is thoroughly explained, along with detail of the actual service to be provided and the approximate time such service is anticipated to take. The customer may then make an informed decision when choosing the service provider. Examples of closing services that may be included on such a customer's disclosure form are: attorneys fees, appraisal fees, credit report fees, title insurance, title searches, courier fees, deed recordings, tax services, flood certifications, survey deletions, homestead document preparations, and escrow waiver fees. Other types of fees, such as brokers and lenders fees, may also be disclosed without departing from the spirit of the invention. Each service will typically be listed along with a detailed explanation of the type of service, the necessity of the service, the approximate time needed to perform the service, and the price offered to the customer by the service provider. Moreover, if any of the fees listed on the disclosure form are to be split between the actual service provider and any other entity, then such split may be disclosed and explained. For instance, often customers are unaware that an attorney may mark up the price of a title insurance policy and split the fee charged to the customer with the title coordinator. Mark ups may also be made on courier fees, recording fees, title searches, etc. Such price and time disclosures on the customer's disclosure form give the customer a better opportunity to make an informed choice of service providers.

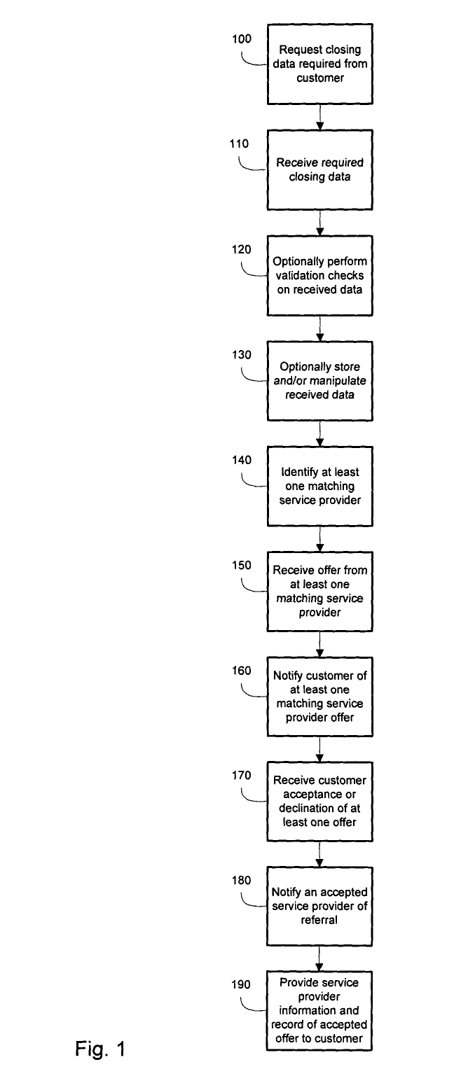

A generalized implementation of one embodiment of the present invention is illustrated in FIG. 1. As shown in FIG. 1, the service provider coordinator, which may be a lender, broker, specific service provider coordination entity, or any other entity capable of implementing the invention, optionally requests 100 the necessary closing data from or about the customer. When the data is received 110, it is optionally validated 120. The data is then optionally stored and/or manipulated 130 prior to identifying 140 at least one matching service provider. An offer is then solicited and received 150 from at least one matching service provider or, alternatively, an offer is constructed from the matching service provider's standard terms. The customer is then notified 160 of at least one matching service provider offer. After the customer decides which, if any, offer to accept, the customer's decision is received 170 and an accepted service provider, if any, is notified 180 of the referral. The service provider information and a record of the accepted offer are then provided 190 to the customer. If desired, information about the transaction, the offer, and/or the customer may be optionally stored for future use.

An embodiment of the invention that takes advantage of the Internet and automated processing tools employs coordination of an electronic closing data form between a customer and a plurality of service providers via the Internet. This embodiment of the method of the present invention comprises the steps of displaying a plurality of documents, including an electronic closing data form, to an Internet user, receiving a plurality of closing data sent from the Internet user via the electronic closing data form, matching the data in the electronic closing data form to at least one suitable service provider by using a filter comprising a plurality of selection criteria, transmitting the closing data to a plurality of suitable service providers via any suitable method, and responding with service provider offers to the Internet user via the Internet. The documents sent to the Internet user typically include a series of questions pertaining to the desired real estate transaction, followed by information about the types of closing services offered. The various types of closing services offered typically include closing attorneys and real estate appraisers, but any type of closing data forms and service providers may be employed without departing from the spirit of the invention.

Upon completion of the data form, the invention matches a unique filter to the closing data entered by the Internet user. The filter is optimally made up of a plurality of selection criteria that a specific service provider has given to the coordinator. The filter is optionally customizable by the specific service provider in real time and is unique to each service provider. Selection criteria may include, but are not limited to, the locale of the service provider, the lending institutions for which the service provider is approved to provide services, and the amount and type of discounts that the service provider offers. Once the data form has been filtered, it is sent to a list of service providers that match with the closing data form. These service providers then reply with offers for closing services to the consumer. In an alternate embodiment, the customer data may be filtered and matched with a standard closing fee structure offered by participating service providers. A list of matching service providers and their costs and discounts may then be sent directly to the customer, via Internet or otherwise, or the list of matching service providers may be sent to the lender who in turn may explain the matching form to the customer.

In a customer-initiated contact with the coordinator, upon selecting the desired service provider the consumer may be provided with a fee discount coupon with tracking number or some other type of voucher that can be redeemed either at, or prior to, the closing by the customer, or via the coordinator. In a lender-initiated referral, the lender and/or coordinator may store the referral data in its data storage system. Other important closing information, such as explanation of services and fees, may also be displayed or provided to the customer, either via the Internet or other suitable method, or by the lender.

In a preferred embodiment of the invention, a computer network keeps track of each step and aspect of the closing transaction. The system tracks each referral—how the referral was originated, who the customer was referred to, the fee owed to the coordinator by the service provider and any fee owed to referring lender or broker. The information outlined above can be sent directly from computer to computer in many different ways. For example, the information can be sent in an Active File Transfer system (AFTS), via e-mail, through a secured web page, or through a Common Gateway Interface (CGI). In addition, since much of the information relayed through the network of computers is private information, it may optionally be encrypted before it is sent from one computer to another, using any suitable method known in the art.

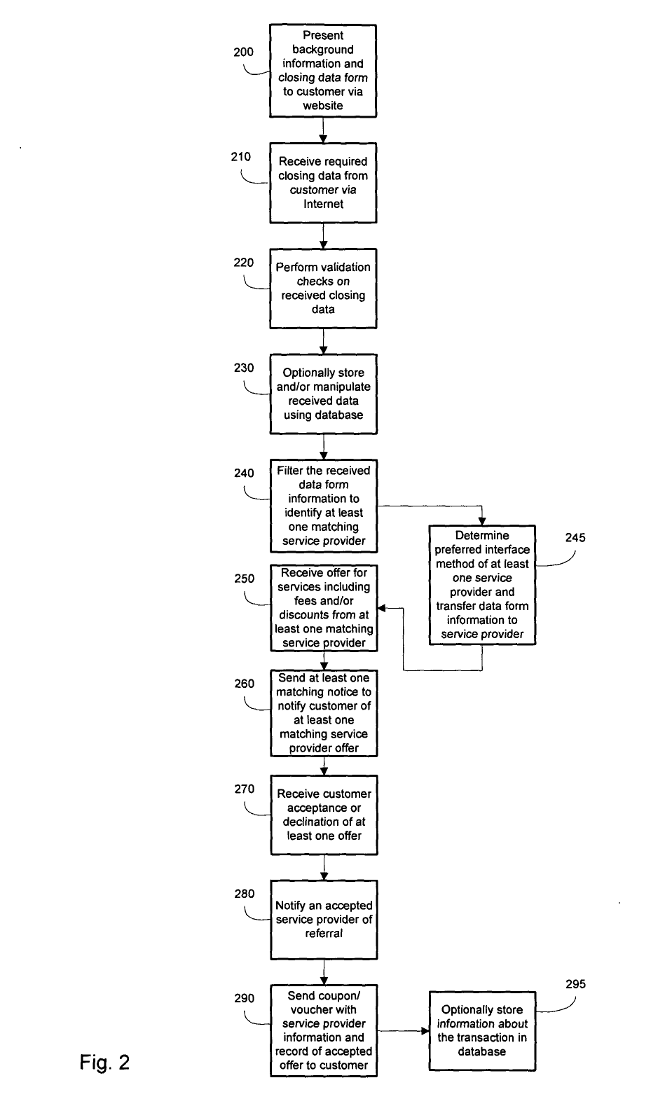

A preferred implementation of the present invention that advantageously makes use of the possibilities presented by the Internet and computerized database processing is shown in FIG. 2. In FIG. 2, real estate closing services are coordinated between customers and closing service providers by a closing service coordinator via the Internet. Initial communication between the service provider coordinator and the customer regarding services is by the Internet, and a computer is employed for coordinating the real estate closings between the service providers and the Internet-using customer.

In one embodiment of this implementation, background information and a closing data form are presented 200 to an Internet user on a web site. Required information is entered by the Internet user into the web site and is received 210 by the coordinating entity or lender. Optional validation checks are performed 220 on this information to make sure that the data form is complete and correct. Information entered on the closing data form is then optionally manipulated and/or stored 230 in a database. The data is then filtered 240 to identify at least one matching service provider by comparing it to a set of criteria established by the service providers. The data is then sent 245 to each one of those service providers having criteria that match the data. This step may involve determination of the preferred interface method for one or more matching service provider. Next, the service provider processes the received data and can either make an offer for services or not. If an offer is received 250 from a service provider, then the Internet user is notified 260 of the match. A reply is received 270 from the Internet user, stating whether the service provider's offer is accepted or declined. An accepted service provider is notified 280 of the referral, and the Internet user is provided 290 with information about the service provider, a record of the accepted offer, and an optional redeemable fee coupon or voucher. Finally, information about the transaction is optionally stored 295 in a database. Such a database provides a record of the transaction for the service provider coordinator, and may optionally allow service providers to have access to their service offer history.

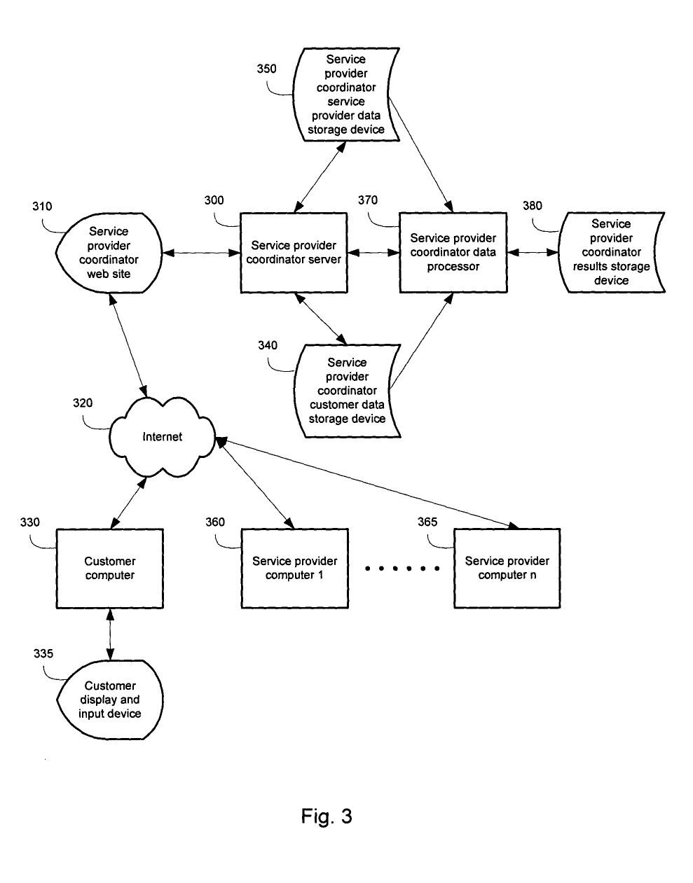

FIG. 3 is a schematic depiction of one embodiment of a network suitable for implementing the embodiment of FIG. 2. In FIG. 3, service provider coordinator server 300 coordinates the various applications and data storage and display devices used in implementing the invention. Server 300 also coordinates the flow of data received from one or more service provider computers and one or more Internet user computers. In this embodiment, server 300 supports web site 310, which is designed to transmit and receive information to and from the customer over Internet 320 via a web browser, such as Netscape or Internet Explorer, installed on customer computer 330.

The required and/or desirable components of a suitable embodiment of server 300, including, but not limited to, such things as required megabytes of RAM, gigabytes of disk space, Internet connection, additional Ethernet connections, operating system, and processor are design details well within the knowledge and capabilities of an Information Technology professional of ordinary skill in the art of implementing systems such as the present invention. Ideally, server 300 will have sufficient memory and processor power to enable multiple customers to interact with web site 310 simultaneously with no apparent performance degradation. Web site 310 may be implemented via any suitable software application using any suitable software language known in the art, such as HTML or XTML.

Server 300 provides background information documents concerning the service provider coordinator's services and the closing service data form to the prospective customer via web site 310. These background information documents typically include a document welcoming the Internet user to the web site, a document explaining the data form process, and a document explaining the services provided. Server 300 also sends an open data form to the Internet user through web site 310 and Internet 320 to customer computer 330 for display and completion via customer display and input device 335. The Internet user inputs information into the data form using customer display and input device 335. Server 300 stores the received data in service provider customer data storage device 340, optionally after validation and/or manipulation. Data storage device 340 may be any suitable device, database, or other storage data structure known in the art.

Optionally, server 300 will initiate edit and validation checks. This may include such things as checking Social Security numbers, addresses, phone numbers, and email addresses entered. The edit and validation checks insure that the data to be stored in customer data storage device 340 is in the proper format for further processing. The data from the completed data form may optionally be encrypted, such as by SSL technology or any other suitable encryption system known in the art, for transmission and/or storage. Typically, the data from the completed data form is sorted and stored in table format in customer data storage device 340 based on the type of service requested (i.e. attorney, appraiser, etc.). Data stored in customer data storage device 340 may also optionally be used to produce reports providing information based on data given any field in the data form (i.e., state of residence, lender, etc.).

In one embodiment, information regarding service provider services, requirements, fees, and/or discounts is stored in service provider coordinator service provider data storage device 350. Server 300 may optionally coordinate collection of service provider data from service provider computers 360, 365 for storage in service provider data storage device 350, either directly via Internet 320, through web site 310, or through an alternate web page. In one embodiment, server 300 also allows service provider computers 360, 365 to access customer information stored in customer data storage device 340 via another web page hosted by server 300.

In one embodiment, server 300 directs data processor 370 to match customer data from customer data storage device 340 to criteria established by each service provider. Service provider criteria may, for example, be stored in a database, typically in table form, in service provider data storage device 350, with a filter hosted by data processor 370 being employed in the matching process.

As an example, the criteria for extending closing service offers established by a first service provider are read. The first criterion is checked against the data provided by a first customer. If there is a match, the filter proceeds to the second criterion, and so on. If there is no match, or there are no more criteria for the first service provider, then processor 370 checks to see whether there is another service provider in service provider database 350. This loop continues until there are no more criteria or service providers available to match to the first customer's data. If there are no more criteria or service providers to match to the customer's data, processor 370 determines whether there has been at least one acceptable match between the customer and a service provider. If there are acceptable matches, then processor 370 selects that service provider, or service providers, as suitable service providers for that customer and stores the results in service provider results storage device 380. If there are no matches, and no remaining service providers in database 350, then a message is generated that no acceptable match has been found, the result is optionally stored in service provider results storage device 380, and the filter process ends.

In one embodiment, server 300 sends customer data from customer data storage device 340 to the service providers selected in the filter process. This may involve determination of the preferred interface method between server 300 and selected service provider computers 360, 365. The interface method can be any suitable means known in the art, including, but not limited to, Common Gateway Interface (CGI), Active File Transfer (AFTS), as a secured file on a secured web page (S.W.), and e-mail, with or without encryption (for example, Pretty Good Privacy (PGP) encryption). Server 300 is able to access many different service provider computers 360, 365, thereby allowing for flexibility within the system.

In an alternate embodiment of the invention, a secured dynamic website serves as a vehicle for service providers to log in to a website in order to change their criteria and to view data forms. To implement this process, information is retrieved by server 300 from customer data storage device 340 and service provider storage device 350 for display on a website that is accessed by the service provider. To access this site, a service provider is typically provided with a login access account enabling it to log into a website that is encrypted by SSL technology or any other suitable encryption scheme known in the art. Once the service provider logs into the website, it can download information relating to an Internet user's request for information. In an alternate embodiment, Common Gateway Interface (CGI) is used by server 300 to send data to service provider computers 360, 365. CGI programs allow for a server-to-server interface over which encrypted information can be transferred.

After notification of the selected service provider, the Internet user is typically provided, via email or other suitable means, with a voucher/redeemable coupon confirming the fee rates and/or discounts offered by the service provider. The loan closing or appraisal can take place in any manner that the service provider typically employs. Once the service provider closes a loan or completes an appraisal, it sends a notification of the completed service and redemption of the coupon or voucher by the Internet user to server 300. Server 300 optionally stores this information in service provider results database 380 that can optionally be accessed by the service providers, and the process is complete as to the current transaction.

The present invention provides a vehicle whereby customers may decide whether they want to pay a premium for extra conveniences or whether they wish to take advantage of discounts on closing services. For instance, attorneys may offer customers additional discounts if the customer closes in the attorney's office during a time period dictated by the attorney. Customers may wish to take advantage of these cost savings by driving themselves to the law office during business hours rather than paying an attorney to drive to them. Attorneys also benefit by spending more of their time performing actual closings, thereby fitting more closings into the work week, instead of having to spend the time traveling to customers and trying to attract business from brokers. Moreover, those attorneys with the best fee structure and best offer for services for customers will be able to attract their business directly from the customer, instead of through the broker or lender, thus discouraging law firm monopolies on closing services.

The present invention allows for greater efficiency and fewer loan rescissions. If a customer rescinds a loan or refuses to go forward with a closing, none of the lender, broker, title coordinator, or attorney is paid. Rescissions therefore cost lenders, brokers, attorneys, and others countless hours of preparation for closing as well as out of pocket costs for titles, municipal lien certificates, etc. The invention also provides a method whereby loan rescissions are minimized, because customers know what to expect at closing and are not surprised by last minute disclosures.

The present invention complies with Federal law, more specifically, with the Real Estate Settlement Procedures Act, and with the American Bar Association's guidelines on fee splitting, in that the coordinator actually provides services to the customer and discloses fees and fee splitting structures to the customer before closing. Services “actually performed” include simplifying and streamlining the cost disclosing process, offering earlier disclosure of closing costs, empowering the consumer by providing choice and an opportunity for discounted fees, educating consumers about closing costs, and offering real discounts and value by cutting closing costs without increasing interest rates and/or raising loan amounts. Fee disclosures are made to the customer prior to closing, and the fee split is also disclosed on the customer's settlement statement as a fee paid outside of closing or, in the alternative, on another appropriate line of the HUD 1 settlement statement.

A lender or mortgage broker-initiated referral to the coordinator can result in an additional fee split between the coordinator and the lender/broker. Disclosure of such fee splitting to the customer may optionally be made on the customer's forms in accordance with applicable state and federal laws and American Bar Association guidelines. When referring a customer to the coordinator, the lender or broker is also actually providing services to the customer. The lender may input the customer's closing data manually to be transferred to the coordinator, or the lender may interface with the coordinator's computer to have necessary data downloaded from the lender's application documents. The lender may provide documentation generated by the coordinator, via the Internet or other suitable method, to the customer. The lender may explain the service provider's disclosures, choice of services, and applicable discount opportunities to the customer. For these and other actual services provided to the customer, the lender or broker may be entitled to a fee split with the coordinator.

Such fee splitting provides an incentive for the lender or broker to participate in the method of the invention. In one aspect of the invention, an attorney who provides closing services may send the coordinator's fee to the coordinator after the completion of the closing. The coordinator may then send the lender's portion of the fee to the lender (if any has been earned by the lender) after the coordinator's receipt of the fee from the service provider. In the alternative, the lender may retain its earned portion of the fee split upon funding the loan to the closing attorney and wire the balance of the loan transaction's funds to the closing attorney. In that instance, the closing attorney then sends the coordinator's fee to the coordinator after closing. In yet another embodiment, the lender may retain its earned portion of the fee as well as the coordinator's earned portion of the closing fee upon funding the loan and then wire the balance of the loan transaction amount to the closing attorney, thus obviating the need for the attorney to send the coordinator its fee after closing. In the alternative, lenders or brokers may choose to include the costs of their participation in the customer's application fee or in other fees paid by the customer at closing. The costs of an additional fee to a potential customer by a lender are minimal in comparison to the cost saving incentives and opportunities that the coordinator and lender offer the customer by utilization of the present invention.

Lenders and mortgage brokers may refer both on-line and off-line customers to the coordinator in order to offer the benefits of the invention to all customers. The coordinator may communicate with customers on-line via email or off-line by telephone, mail, or any other suitable means known in the art. In the alternative, the lender may communicate directly with the coordinator on behalf of the customer.

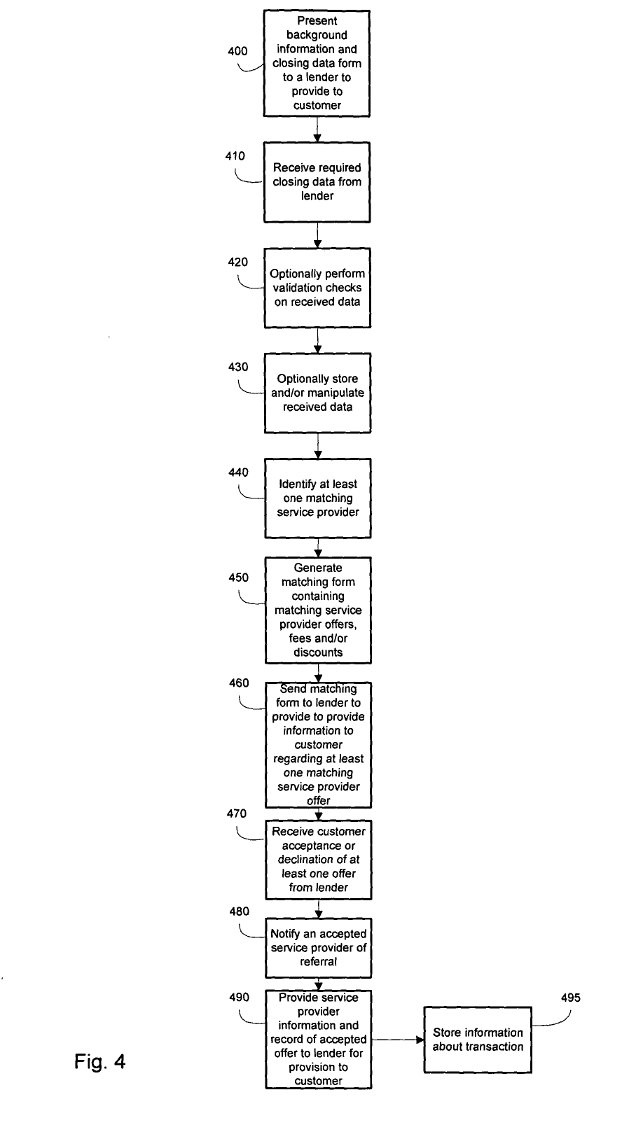

FIG. 4 outlines the basic steps of one embodiment of the system of the invention, wherein a lender is utilized as an intermediary between the customer and the closing service provider coordinator. In the embodiment of FIG. 4, a lender provides the interface between the customer and the service provider coordinator. In this embodiment, the service provider coordinator presents 400 the lender with background information and a closing data form for provision to the customer. The lender collects the necessary data from the customer to be used in the matching process. When the data is received 410 by the coordinator, the coordinator optionally validates 420, stores 430, and/or manipulates the data and then uses it to identify 440 at least one matching service provider. A matching form is generated 450, containing matching service provider offers, fees, and/or discounts. The matching form is sent 460 to the lender for provision of information to the customer regarding at least one matching service provider offer. The customer's acceptance or declination of the offer or offers is received 470 from the lender, and any accepted service providers are notified 480. Finally, service provider information and a record of the accepted offer are provided 490 to the lender for provision to the customer, and information about the transaction is stored 495.

In a typical embodiment of this type, either the customer data is entered by the lender into the coordinator database via the Internet, or the data is provided to the coordinator by fax or other means of communication. The coordinator typically performs validation checks on the information to ensure that accurate and complete data has been provided. If further or clarified information is needed, the coordinator contacts the lender to obtain the missing information from the customer. The correct customer information is stored in the coordinator's database and then filtered to identify matching service providers who can perform the required closing services for the customer. If offers are to be made via the Internet in real time, such as on the coordinator's web site so that service providers can update or change their fee information and service offers at any time by accessing the Internet, then the coordinator determines the communication method to be utilized to provide the customer's data to the service provider. The data is sent to the service provider for a review that enables the service provider to generate an offer. If the service provider had pre-provided offers for services that are fixed and not accessible for continuous updating, then this step is skipped.

A matching form is generated outlining the service provider's service fees and discounts (if any). A matching notice is sent to the lender so that the lender can explain the forms to the customer. The customer chooses a service provider and the lender communicates the choice to the coordinator. The coordinator notifies the service provider of the choice. Typically, notice of the match and a record of the service provider's offer are sent to the lender by the coordinator via the Internet or other means of communication. After the closing is completed, the coordinator is notified by the lender and/or service provider and information about the completed transaction is stored in the database.

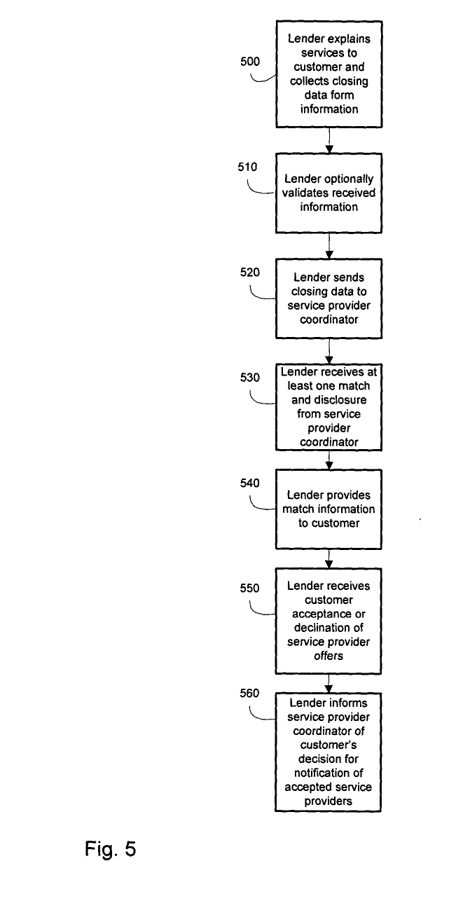

FIG. 5 illustrates another embodiment of the method of the present invention, wherein a lender employs a service provider coordinator and continues to provide services to the customer throughout the matching process. As shown in FIG. 5, the lender explains the various closing services to the customer and collects 500 the required closing data form information. The lender optionally validates 510 the collected information and then sends 520 the data to the service provider coordinator. The lender then receives 530 notice of at least one match, along with disclosure of the various fees, discounts, etc, from the service provider coordinator, which information the lender then provides 540 to the customer. Next, the lender receives 550 the customer's choice among the various service provider offers, and provides 560 that decision to the coordinator for notification of the selected service providers.

In a typical implementation of this embodiment, both the coordinator and the lender provide services to the customer for which compensation is allowed under RESPA and other relevant rules and regulations. Typically, the customer initially contacts the lender about a loan. The lender then explains the coordinator's matching services to the customer, a service provided by the lender to the customer for which the lender may be compensated, and may ask the customer if he/she wishes to utilize the coordinator's services. If so, the lender collects the customer's closing information, a service provided by the lender to the customer for which the lender may be compensated, and enters the customer's information into the coordinator's database via the Internet, also a service provided by the lender to the customer for which the lender may be compensated. Alternatively, the lender may be networked with the coordinator, so that the customer's information is automatically taken from documents that have been entered into the lender's database, such as the customer's initial application or a standard form generated by the lender and the coordinator for purposes of transmitting customer information, which is also a service provided by the lender to the customer for which the lender may be compensated. In an alternate embodiment, the lender provides the information to the coordinator by fax or phone and the coordinator then enters the customer information into the coordinator database (also a service provided by the lender to the customer for which the lender may be compensated). Preferably, the lender and/or the coordinator will confirm receipt of the customer's information.

After the coordinator filters the data, the coordinator provides matching forms to the lender which the lender provides to the customer, a service provided by the lender to the customer for which the lender may be compensated, and then the lender explains the forms to the customer, also a service provided by the lender to the customer for which the lender may be compensated. After the customer makes a service provider choice, the lender records the customer's choice of service provider and informs the coordinator, a service provided by the lender to the customer for which the lender may be compensated. The lender may do this by, for example, entering the customer's choice into the coordinator's database via the Internet or by informing the coordinator via fax or other means of communication so that the coordinator may enter the customer's choice into its own database. Next, the coordinator or, alternatively, the lender, informs the service provider of the customer's choice. The service provider then contacts the customer and completes the closing. The service provider may pay the coordinator a referral fee for services provided to the customer by the coordinator. The coordinator may then, in one alternative, pay the lender a referral fee for the service provided to the customer by the lender or, in another alternative, the lender may collect a fee for its services from the customer at the onset of the process.

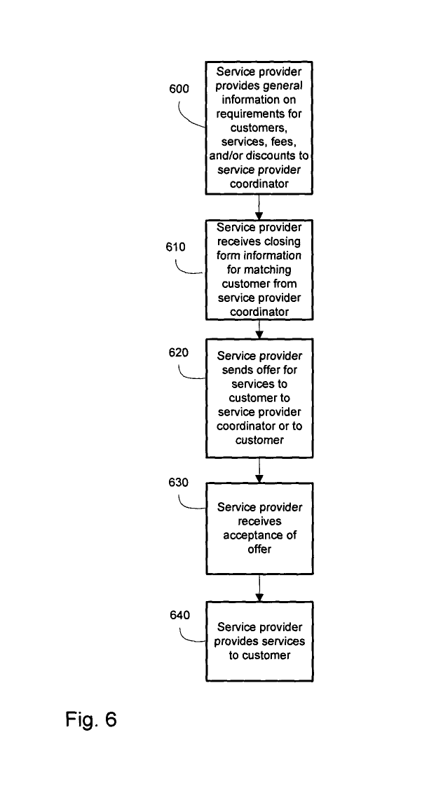

FIG. 6 illustrates yet another embodiment of the method of the present invention, wherein a service provider utilizes the services of a coordinator in order to provide customers with offers of services. As show in FIG. 6, a service provider provides 600 information on its requirements and criteria for customers, services, fees, and/or discounts to the service provider coordinator. After a match is made by the coordinator, the service provider receives 610 closing form data from the coordinator. The service provider then sends 620 an offer to the coordinator or, alternatively, directly to the matching customer. The service provider receives 630 an acceptance of its offer, and provides 640 the accepted services to the customer.

In a typical implementation of this embodiment, the customer initially contacts the coordinator via the Internet or other communication means in order to utilize the coordinator's service. The coordinator explains the services to the customer via the Internet, a web site, phone, fax, or by any other communication means known in the art. The customer enters his/her data into the coordinator database via the Internet, or the customer communicates the data to the coordinator by other means such as by phone, and the coordinator enters and stores the information into its database. After the coordinator filters the customer data against the general service provider requirements previously provided to the coordinator by the service provider and makes a match of service providers for the customer, the coordinator sends customer information to the service provider so that the service provider may make an offer of services. The matching information is sent to the customer via the Internet or by other means of communication, either directly from the service provider or through the coordinator. The customer reviews the matching information and chooses a service provider. The customer informs the coordinator or the service provider of the customer's choice via the Internet or other means of communication. If necessary, the coordinator then informs the service provider via any suitable form of communication. The service provider then provides the closing services for the customer. The service provider may split its fee with the coordinator to pay for the services provided to the customer by the coordinator.

The present invention may be advantageously implemented utilizing any of the large number of variants of the steps and structures previously discussed that would be apparent to one of ordinary skill in the art of the invention. Some of the suitable variations of the method of the invention are disclosed below, but it is to be understood that the present invention is not limited to the discussed variations and that any of the numerous variations possible are within the scope of the invention.

One example embodiment of the method of the invention provides for coordination of an electronic data form between a customer or lender/mortgage broker and a plurality of closing service providers via the Internet or other suitable mechanism known in the art, and comprises the steps of:

a) receiving provider criteria from the plurality of service providers, the criteria including, but not limited to, fee structure, discounts offered, office location, and list of lending institutions for which service provider has been approved to provide closing services;

b) storing the provider criteria in a database;

c) displaying a plurality of documents in a web site for acquisition of customer closing data;

d) receiving a plurality of customer closing data sent from the customer or lender/mortgage broker including, but not limited to, location of real estate, preferred date, time and/or location of closing, and lender to be utilized at closing;

e) filtering the customer closing data with a filter comprising the plurality of provider criteria to select, preferably without manual intervention, one or more closing service providers associated with a match of the closing data to the provider criteria;

f) determining an appropriate transfer method to transmit the information to the customer, either through the Internet, lender or directly to the customer or transmitting the electronic data form or other referral form to the plurality of service providers associated with a match of the form data via the appropriate transfer method to allow service providers to make offers for closing services via a service provider matching form;

g) receiving a plurality of closing service offers from the service providers associated with a match of the closing data on closing data form or generating a list of pre-determined closing service offers from the service providers associated with a match of the closing data on closing data form;

h) displaying the plurality of matching closing service provider's offers to the customer on the web site, or through the lender, or directly to the customer by fax or mail, via a service provider matching form;

i) receiving, via the web site or otherwise, at least one decision from the customer regarding at least one of the matching service provider's offers, the Internet user's or customer's decision comprising an acceptance, denial or request for more information regarding a service provider and/or its services and the providers rates and discount offers for one of the providers associated with a match of the closing data;

j) transmitting to the customer, via email, the lender, or other suitable method, an electronic coupon with tracking redemption number to the customer to use for discounts and/or a record of the closing service provider's offer; and

k) transmitting or communicating the customer's decision to utilize closing service from at least one service provider corresponding with a positive data match to the service provider, along with a record of internet user's or customer's valid tracking redemption number or other such record of transaction to be redeemed at or prior to closing.

Preferably, in this embodiment step (c) comprises the steps of displaying a document welcoming the Internet user or customer; displaying a document explaining the electronic or otherwise closing data form process; displaying a document explaining the services provided by participating service providers (e.g. attorneys and appraisers); and displaying the closing data form. In another preferred embodiment of this method, step (d) further comprises the steps of verifying data input in a closing data form on a web site or otherwise and storing the plurality of closing data in a database table in a storage device.

In one preferred embodiment of the method and apparatus of the present invention, each service provider is assigned a corresponding filter comprising closing services offer criteria customizable by the service provider. In another preferred embodiment of the method of the invention, step (e) further comprises the steps of advancing to the first of the service offer criteria of the filter; comparing the selection criteria to the corresponding closing data on the closing data form; proceeding to the next level of the service offer criteria if the comparison is successful; and proceeding to the next level of the filter if the comparison is unsuccessful.

In one embodiment of the method of the invention, an electronic service provider matching form comprised of service provider's offers to the customer associated with a match of the closing data is transmitted to the lender and/or customer via a Common Gateway Interface (CGI), a secured website, a secured E-Mail, via any other suitable Internet-related mechanism, or by any other suitable method known in the art. In another embodiment of the invention, a notification of successful transmission of the electronic closing data form from the plurality of service providers associated with a match of the closing data or receiving notification is received from lender and/or customer via any suitable method of communication.

In another embodiment of the invention, the step of transmitting the Internet user's or customer's decision comprises the step of collecting the decision and assigning a tracking number to each decision and storing the decision and tracking number in a storage device. The method may also include the step of receiving a notification of a completed real estate closing and verification of redemption of service provider discount coupon and/or verification of internet user's tracking number on the discount coupon, or verification of fees charged at closing from one of the service providers associated with a match of the closing data and/or the step of generating a plurality of reports comprising the offers for closing services for the plurality of service providers; and displaying the plurality of reports to the internet user or customer or lender. In one embodiment, the step of generating a plurality of reports further comprises the step of generating reports to include location of service provider, list of service provider's acceptance of discount(s) for service provider's fee, good faith estimates and detailed explanations of service provider's services and fee(s) to be charged at closing.

An embodiment of a network system for coordinating the submission of a closing data form by a lender or customer via the coordinator to a plurality of service providers according to the invention may comprise, for example:

a database for storing and receiving service provider criteria data from the plurality of service providers;

means for inputting closing form data from a prospective customer into the network system;

means for entering service provider criteria data into the network system, the service provider criteria data being associated with each of the service providers and useful for the customer in selecting a low cost or discounted closing service;

computing means for comparing the closing data form data to the service provider criteria data of the database, the computing means operative to identify a plurality of service providers associated with a match of the closing data form data to the service provider criteria data as a possible candidate for selection of closing services by the customer, the computing means further operative to transmit the closing data form data to a selected number that is less than the identified service providers or a random number of the service providers via the communicating means, the selected number comprising two or more identified service providers when a plurality of service providers exists, the computing means also operative to transmit the closing data form data to the selected number of the identified service providers without a delay for reception of any selection decisions received from the internet user associated with a match of the closing data if Internet is utilized, the computing means also operative to receiving and simultaneously or otherwise displaying a plurality of service provider matches on a web site or otherwise from the identified service providers that received the closing data regarding an offer of use of services, the computing means further operative to determine an appropriate transfer method to transmit the closing data form data to service providers associated with a match of the closing data, the computing means further operative to receive from the web site or lender or customer at least one internet user's or customer's decision and to transmit the at least one internet user's or customer's decision to at least one service provider corresponding with a positive closing data match, the internet user's or customer's decision comprising an acceptance, denial or request for more information regarding a service provider for one of the service providers associated with a match of the closing data, whereby the selected number of the identified service providers compete with each other for business with the internet user or customer; and

communicating means, connecting the means for closing data form data and the means for inputting closing services criteria data to the computing means, for allowing the connected components to communicate with each other.

In one configuration of this embodiment, the database is connected to the computing means, for storing the closing data form data and the service provider criteria data. The communicating means may be the Internet or any other suitable medium known in the art. In one embodiment, the means for inputting closing data form data and service provider criteria data comprises a computer connected to the Internet. The computing means may comprise an Internet server connected to remote computers on the Internet, or a lender server connected to remote computers on the Internet, or any other suitable device known in the art.

An embodiment of a computer-implemented method for coordinating submission of an electronic closing data form between a consumer and a plurality of service providers via a distributed computer network according to the present invention may comprise the steps of:

receiving selection criteria from the plurality of service providers; storing the selection criteria in a database;

receiving closing data for the electronic closing data form from the consumer via the distributed computer network or otherwise;

comparing the closing data to the selection criteria of the database, the selection criteria being useful for selecting a successful closing data form match and corresponding to each of the plurality of service providers;

in response to the closing data satisfying the selection criteria, identifying each service provider associated with a match of the closing data to the selection criteria as a possible candidate for providing closing services to the customer;

determining an appropriate transfer method to forward the closing data to the service providers associated with a match of the closing data;

forwarding the closing data to a selected number of matching service providers associated with a match of the closing data to the selection criteria via the determined appropriate transfer method, the forwarding of the closing data occurring without a delay for reception of any closing decisions by the customer associated with a match of the closing data to a service provider, the selected number of matching service providers being less than a total number of the identified matching service providers and being greater than one when a plurality of identified service providers exists;

receiving positive offers of use of services from the identified service providers that received the closing data; and either (a) creating a dynamic personal web site accessible by the consumer via the distributed computer network; publishing an offer from each identified service provider that received the closing data on the dynamic personal web site; receiving at least one decision via the dynamic personal web site from the consumer regarding at least one of the matching service providers, the consumer's decision comprising an acceptance, denial or request for more information regarding a matching service provider for one of the service providers associated with a match of the closing data; and transmitting at least one consumer decision to at least one service provider corresponding with an offer for use of services via the distributed computer network, or

(b) publishing an offer from each identified service provider that received and matched with the closing data to customer directly or via lender; receiving at least one decision from the consumer regarding at least one of the matching service providers, the consumer's decision comprising an acceptance, denial or request for more information regarding a matching service provider for one of the service providers associated with a match of the closing data; and transmitting at least one consumer decision to at least one service provider corresponding with an offer for use of services via the distributed computer network, or otherwise, whereby the selected number of service providers compete with each other for business with the consumer.

One embodiment of this method also includes the step of providing the electronic closing data form to the identified service providers by transmitting the closing data to the identified service providers via the distributed computer network or otherwise displaying data form. In one embodiment, the comparing step comprises:

(a) obtaining the selection criteria for a selected one of the service providers;

(b) determining whether the closing data satisfies the selection criteria for the selected service provider;

(c) if so, then identifying the selected service provider as a candidate for providing closing services to the internet user;

(d) otherwise, determining whether selection criteria is available for a remaining one of the service providers; and

(e) continuing steps (a)-(d) for each one of the remaining service providers.

The optional computing means, responsive to the decision of customer, may optionally be operative to send the decision to each identified service provider via the correct communicating means and to store the decision in a storage device coupled to the computing means.

An alternate embodiment of the invention is a computer-readable medium having computer executable instructions for coordinating submission of an electronic closing data form between a consumer or lender and a plurality of service providers, comprising:

receiving selection criteria from the plurality of service providers; storing the selection criteria in a database;

receiving closing data for the electronic closing data form from the consumer; comparing the closing data to the selection criteria of the database, the selection criteria useful for selecting a successful closing data form and defined by each of the service providers based on their particular closing service capabilities;

in response to the closing data satisfying the selection criteria, identifying each service provider associated with a match of the closing data to the selection criteria as a possible candidate for providing closing services to the consumer;

selecting a predetermined number of the matching service providers and forwarding the closing data to the selected set of the matching service providers, the forwarding of the closing data occurring without a delay for reception of any offers for closing services from the service providers associated with a match of the closing data, the predetermined number being less than a total number of the matching service providers previously identified and being greater than one when a plurality of identified service providers exists;

receiving a plurality of offers for closing services from the matching service providers of the selected set regarding an offer of closing services to the consumer; displaying information including each closing service provider's offer to the consumer advising that the selected set of the matching service providers represents possible candidates for providing closing services to the consumer, thereby providing the consumer with the opportunity to accept the closing service offer from one of the selected set of identified service providers, such that the selected set of identified service providers competes for business with the consumer;

determining an appropriate transfer method to transmit the closing data form to each selected one of the matching service providers; sending the closing data form to each selected one of the matching service providers via the appropriate transfer method;

accepting a consumer's decision via a web site or otherwise regarding the offer of closing services from the selected ones of the matching service providers, the consumer's decision comprising an acceptance, denial or request for more information regarding an offer for closing services for one of the service providers associated with a match of the closing data; and

forwarding the consumer's decision to the selected ones of the matching service providers.

In one embodiment, the computer-executable instructions for completing the comparing step may comprise:

(a) obtaining the selection criteria for a selected one of the service providers;

(b) determining whether the closing data satisfies the selection criteria for the selected service provider;

(c) if so, then identifying the selected service provider as a candidate for providing closing services to the internet user;

(d) otherwise, determining whether selection criteria is available for a remaining one of the service providers; and

(e) continuing steps (a)-(d) for each one of the remaining ones of the service providers.

The computer-readable medium of an embodiment of the invention may optionally include at least one or more of: computer-executable instructions for providing the closing data form to only the selected set of the matching service providers by transmitting the closing data to the selected set of the matching service providers via a distributed computer network or other means; computer executable instructions for sorting the closing data, prior to the step of comparing the closing data, based on the type of closing service requested by the consumer; and executable instructions for accepting at a secured website changes to the selection criteria for one of the selected matching service providers, thereby enabling the service provider to customize its offer on a real-time basis. In one embodiment, the computer executable instructions for forwarding the closing data comprise transmitting the closing data to a secured website accessible by the selected ones of the matching service providers, the closing data published at the secured website for review by only the selected ones of the matching service providers, or by transmitting closing data by other means such as by fax.

The computer-readable medium of the invention may further comprise executable instructions for accepting a notice of a completed real estate closing in response to the consumer selecting the closing service of one of the selected set of matching service providers. In one embodiment, this may be implemented by: forwarding the closing data to the service providers associated with a match of the closing data via a Common Gateway Interface (CGI); forwarding the closing data to the service providers associated with a match of the closing data via the first secured website; forwarding the closing data to the service providers associated with a match of the closing data via a secured E-Mail; and forwarding the closing data to the service providers associated with a match of the closing data via fax or other means.

An alternate embodiment of the present invention is a method for coordinating an electronic closing data form between an Internet user and a plurality of service providers via the Internet, comprising the steps of:

generating a first web site for receiving selection criteria from the plurality of service providers, the first website comprising a secured dynamic website; obtaining selection criteria from the plurality of service providers with the first website; storing the selection criteria in a database;

displaying an electronic closing data form in a second website;

obtaining closing data from the Internet user with the electronic closing data form; applying the closing data to a filter comprising the plurality of selection criteria of the database to select without manual intervention each one of the plurality of service providers associated with a match of the closing data to the selection criteria; determining an appropriate transfer method to forward the closing data to the service providers associated with a match of the closing data;

forwarding the closing data to a selected number of service providers associated with a match of the closing data, the selected number of service providers being less than a total number of identified matching service providers, and being greater than one when a plurality of identified service providers exists, the forwarding of the closing data occurring without a delay for reception of any offer of closing services decisions from the service providers and via the appropriate transfer method;

receiving a plurality of offers for closing services from the plurality of service providers associated with a match of the closing data;

displaying the plurality of offers for closing services to the Internet user; establishing communication between one or more of the selected number of service providers associated with a match of the closing data and the Internet user so that the Internet user can obtain closing services from one of the selected service providers associated with a match of the closing data, whereby the service providers associated with a match of the closing data compete with each other for business with the Internet user; receiving at least one decision via the second web site from the Internet user regarding at least one of the offers for closing services, the Internet user's decision comprising an acceptance, denial or request for more information regarding an offer for closing services from one of the service providers associated with a match of the closing data; and

transmitting the at least one Internet user's decision to at least one service provider corresponding with an offer for closing services.

The present invention provides a method whereby all closing costs, fixed or otherwise, are explained to and disclosed to the customer before closing in order to allow the customer sufficient information and time to make an informed choice of service providers. It allows the customer to choose the closing costs and to get a commitment from the closing attorney, not merely from the lender who frequently will make changes and add new requirements during the lending process. By allowing the customer to choose the attorney personally and to review and agree to the offered costs early in the closing process, the customer is prepared to pay the agreed closing service costs at closing without surprise. The invention further drives attorneys and other service providers to compete for business by offering their best available fees and discounts. Further, the invention allows the attorney to fee-split with the coordinator, and the coordinator to fee-split with the lender, because both the coordinator and the lender provide actual and valuable services to the customer.

Because the present invention is a method and process whereby attorneys and other service providers are driven to compete, consumers benefit and monopolization in the real estate closing industry is discouraged. Moreover, the invention provides incentive to lending institutions to participate in offering borrowers a choice of services and better disclosure of actual closing costs earlier in the closing process. In accordance with the invention, needless repetitive phone calls and cost requests are eliminated.

The apparatus and method of the present invention, therefore, provide a method and apparatus for coordinating lenders, borrowers and a plurality of service providers that allows consumers to choose closing services from among a number of service providers via a fast, convenient process. In the preferred embodiment, this invention provides a customer with an electronic closing data form that may then be submitted by the customer or lender via the Internet to a plurality of matched service providers who in turn respond to the customer or lender over the Internet with offers of services from which the customer may select. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A method for coordinating real estate closing services comprising the steps, in combination, of:
receiving real estate closing information from a customer or lender;
identifying at least one matching real estate closing service provider by comparing, using an automated process, the received closing information to stored service provider criteria;
communicating, to the customer or lender, at least one service provider offer from an offering matched service provider;
receiving at least one service provider offer selection from the customer or lender;
notifying at least one selected service provider of the service provider offer selection; and
providing a record of the selected service provider offer to the customer or lender.

2. The method of claim 1, further comprising the step of initially requesting the real estate closing information from the buyer or lender.

3. The method of claim 1, further comprising the step of validating the received closing information.

4. The method of claim 1, further comprising the step of storing the received closing information.

5. The method of claim 1, further comprising the step of storing information relating to the selected service provider offer.

6. The method of claim 1, further comprising the steps of:
receiving notification of a completed real estate closing; and
storing information about the completed real estate closing.

7. The method of claim 1, further comprising the steps of:
receiving service provider criteria; and
storing the received service provider criteria.

8. A method for coordinating real estate closing services via the Internet comprising the steps, in combination, of:
presenting a closing data form to a customer via a web site;
receiving customer closing information from the customer via the Internet;
electronically validating the received customer closing information;
electronically comparing the received customer closing information to stored real estate closing service provider criteria to identify at least one matching service provider;
communicating the received customer closing information to at least one matching closing service provider;
receiving at least one offer for services to the customer from at least one offering service provider;
providing, via the Internet, at least one matching notice to the customer to notify the customer of the offer for services from the offering service provider;
receiving, via the Internet, at least one customer service offer acceptance;
notifying an accepted service provider of the customer service offer acceptance; and
sending a voucher containing a record of the offer for services and the customer service offer acceptance to the customer.

9. The method of claim 8, further comprising the step of storing information about the offer for services and the customer service offer acceptance in an electronic database.

10. The method of claim 9, further comprising the steps of:
receiving notification of a completed real estate closing; and
electronically storing information about the completed real estate closing.

11. The method of claim 8, further comprising the steps of:
receiving service provider criteria; and
storing the received service provider criteria.

12. A method for coordinating real estate closing services comprising the steps, in combination, of:
receiving customer real estate closing information from a customer;
communicating the customer real estate closing information to a service provider coordinator;
receiving at least one service provider offer from the service provider coordinator, the service provider offer having been obtained by the service provider coordinator after comparing, through an automated process, the customer real estate closing information to service provider criteria;
communicating at least one received service provider offer to the customer;
receiving at least one service provider offer selection from the customer; and
notifying the service provider coordinator of the service provider offer selection.

13. The method of claim 12, further comprising the step of providing a record of the service provider offer and the service provider offer selection to the customer.

14. The method of claim 13, further comprising the step of storing the received real estate closing information.

15. The method of claim 14, further comprising the step of storing information relating to the service provider offer selection.

16. A method for coordinating real estate closing services comprising the steps, in combination, of:
providing at least one service provider criterion to a service provider coordinator for matching with customer real estate closing information;
receiving customer real estate closing information for a matching customer from the service provider coordinator, the matching customer having been identified by the service provider coordinator after comparing, through an automated process, the customer real estate closing information to service provider criteria;
transmitting a service offer to the service provider coordinator or matching customer;
receiving an acceptance of the transmitted service offer; and
providing services to the matching customer in accordance with the accepted service offer.

17. A computer-readable medium having computer-executable instructions for coordination of real estate closing services between a customer, a lender, and a plurality of closing service providers, comprising:
storing selection criteria of a plurality of real estate closing service providers;
receiving customer closing information from a customer;
comparing the received customer closing information to the stored selection criteria to identify at least one matching closing service provider;
communicating the received closing information to at least one matching closing service provider;
receiving at least one offer for services to the customer from at least one offering service provider;
transmitting at least one offer for services to the customer;
receiving at least one customer service offer acceptance; and
notifying an accepted service provider of the customer service offer acceptance.

18. The computer-readable medium of claim 17, further comprising computer-executable instructions for transmitting a record of the offer for services and the customer service offer acceptance to the customer.

19. The computer-readable medium of claim 17, further comprising computer-executable instructions for receiving notification of a completed real estate closing and storing information about the completed real estate closing.

20. The computer-readable medium of claim 17, further comprising computer-executable instructions for storing received customer closing information and information relating to the selected offers for services.
